(19) United States
(12) Patent Application Publication
(10) Pub. No.: US 2014/0106817 A1
(43) Pub. Date: Apr. 17, 2014

(54) Multifunction, portable communication device

(71) Applicant: Hsin-Chen Lin, Kaohsiung (TW)

(72) Inventor: Hsin-Chen Lin, Kaohsiung (TW)

(21) Appl. No.: 14/047,042

(22) Filed: Oct. 7, 2013

(30) Foreign Application Priority Data
Oct. 12, 2012 (TW) 101137632

(51) Int. Cl. H04M 1/02

(52) U.S. Cl. CPC H04M 1/0279
USPC 455/557

(57) ABSTRACT

A multifunction, portable communication device is provided with a solar cell disposed on a top surface, a USB port disposed on an edge, a PCB electrically connected to the USB port, a keypad disposed on the top surface and electrically connected to the PCB, a rechargeable battery electrically connected to both the solar cell and the PCB, and an IR heating member electrically connected to the PCB, the keypad, and the rechargeable battery respectively, the IR heating member including an electromagnetic radiation member.

### BACKGROUND OF THE INVENTION

1. Field of the Invention

The invention relates to portable communication devices and more particularly to a multifunction, portable communication device that in addition to telephony, further incorporates functions including body warming and hair shaving.

2. Description of Related Art

Mobile phones, in addition to telephony, have evolved to smartphones which offer functions or services such as text messaging, Multimedia Messaging Service (MMS), email, Internet access, short-range wireless communications, business applications, gaming and photography.

However, frequent use of any mobile phone may cause injury to hands, wrists, arms, or neck.

Thus, the need for provision of a multifunction, portable communication device exists.

### SUMMARY OF THE INVENTION

It is therefore one object of the invention to provide a multifunction, portable communication device comprising a parallelepiped housing including a solar cell disposed on a top surface and a USB port disposed on an edge; a PCB disposed in the housing and electrically connected to the USB port; a keypad disposed on the top surface of the housing and electrically connected to the PCB; a rechargeable battery disposed in the housing and electrically connected to both the solar cell and the PCB; and an IR heating member disposed in the housing and electrically connected to the PCB, the keypad, and the rechargeable battery respectively, the IR heating member including an electromagnetic radiation member.

The above and other objects, features and advantages of the invention will become apparent from the following detailed description taken with the accompanying drawings.

### BRIEF DESCRIPTION OF THE DRAWINGS

FIG. 1 is a perspective view of a multifunction, portable communication device according to a first preferred embodiment of the invention;

FIG. 2 is a perspective view of a multifunction, portable communication device according to a second preferred embodiment of the invention;

FIG. 3 is a perspective view of a multifunction, portable communication device according to a third preferred embodiment of the invention; and

FIG. 4 is a perspective view of a multifunction, portable communication device according to a fourth preferred embodiment of the invention.

### DETAILED DESCRIPTION OF THE INVENTION

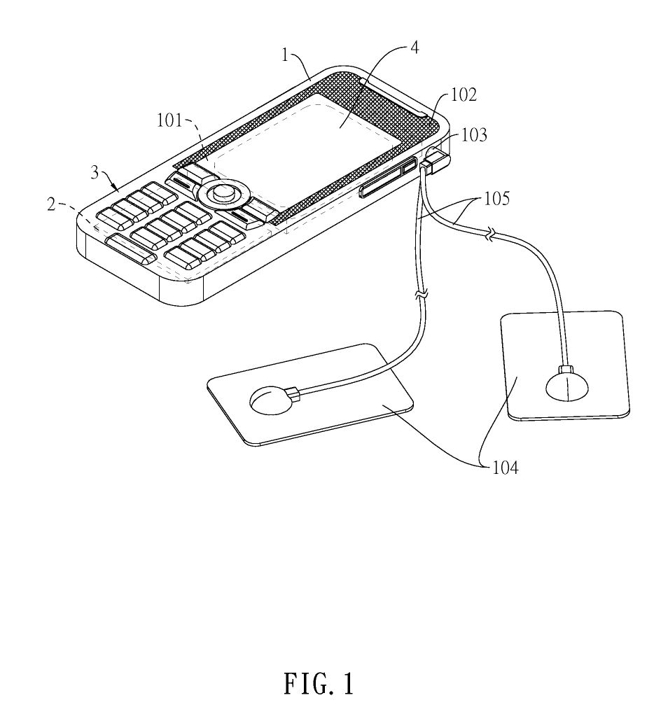

Referring to FIG. 1, a multifunction, portable communication device in accordance with a first preferred embodiment of the invention is implemented as a mobile phone and comprises the following components as discussed in detail below.

A parallelepiped housing 1 includes an internal space 101, a solar cell 102 on a top surface, a port (e.g., Universal Serial Bus (USB) port) 103 on one side edge, and two mice 104 connected to the port 103 via two cords 105 respectively.

A printed circuit board (PCB) 2 as controller is disposed in the space 101.

A keypad 3 is disposed on a portion of the top surface of the housing 1 and electrically connected to the PCB 2.

A rechargeable battery 4 is disposed in the space 101 of the housing 1 and electrically connected to both the solar cell 102 and the PCB 2. The solar cell 102 converts the energy of light directly into electricity by the photovoltaic effect, stores the electricity in the rechargeable battery 4, and supplies electric power to all of above components for their normal operations. Further, the PCB 2 can supply a small current of low frequency from the rechargeable battery 4 to the mice 104.

A user may press key(s) or button(s) of the keypad 3 to, for example, turn on, turn off, execute a function, dial, or receive a call.

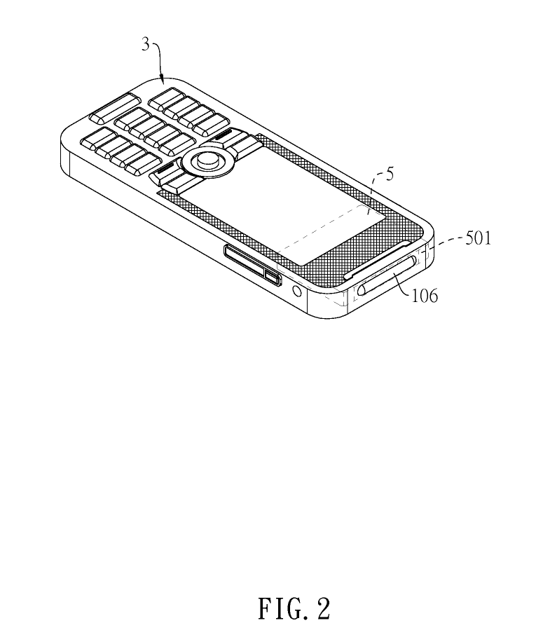

Referring to FIG. 2 in conjunction with FIG. 1, a multifunction, portable communication device in accordance with a second preferred embodiment of the invention is shown. The characteristics of the second preferred embodiment are substantially the same as that of the first preferred embodiment except the following:

The mice 104 and the cords 105 are eliminated. An infrared (IR) heating member 5 is provided in the housing and electrically connected to the PCB 2, the keypad 3, and the rechargeable battery 4 respectively. A lens 106 is provided on a front edge of the housing 1. The IR heating member 5 includes an electromagnetic radiation member 501 behind the lens 106.

A user may manipulate the keypad 3 to activate the IR heating member 5. And in turn, the electromagnetic radiation member 510 emit IR light through the lens 106 toward an uncomfortable portion of the body for heating, thereby making muscles supple and having other health benefits including resolving pain.

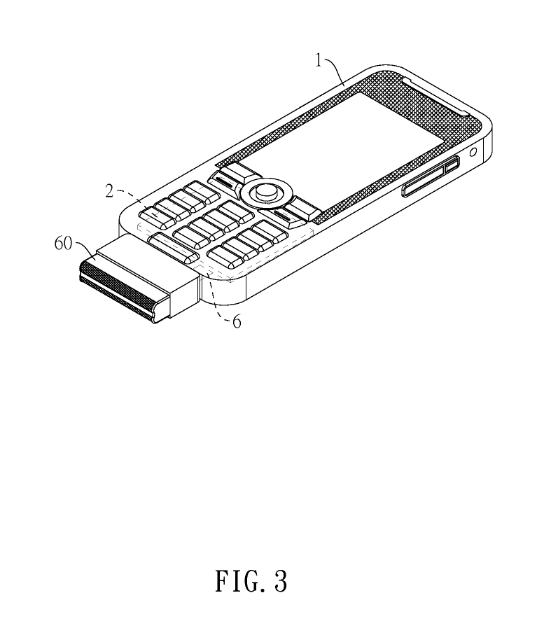

Referring to FIG. 3 in conjunction with FIG. 1, a multifunction, portable communication device in accordance with a third preferred embodiment of the invention is shown. The characteristics of the third preferred embodiment are substantially the same as that of the first preferred embodiment except the following:

The mice 104 and the cords 105 are eliminated. A DC (direct current) motor 6 is provided in the housing 1 and electrically connected to the PCB 2. An electric razor 60 is projected out of a bottom edge and powered by the DC motor 6.

A user may manipulate the keypad 3 to activate the DC motor 6. And in turn, the electric razor 60 is activated to remove unwanted body hair through the act of shaving.

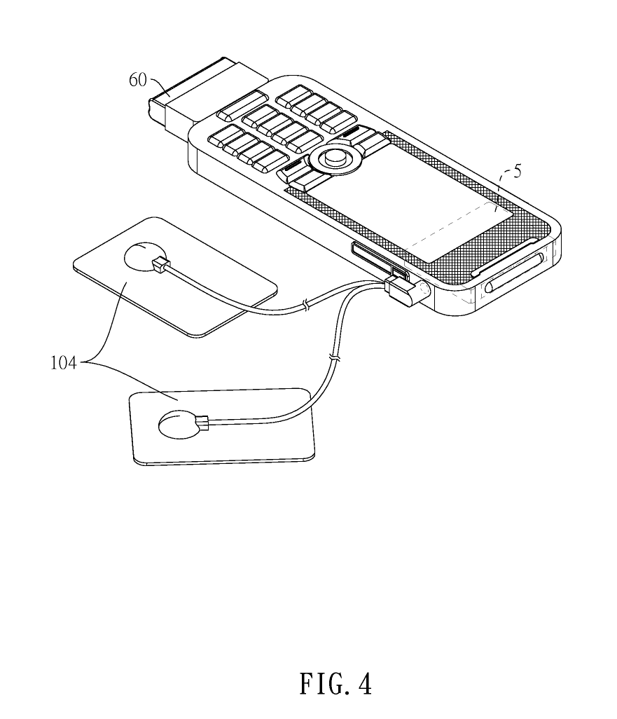

Referring to FIG. 4 in conjunction with FIGS. 1, 2 and 3, a multifunction, portable communication device in accordance with a fourth preferred embodiment of the invention is shown. The characteristics of the fourth preferred embodiment are substantially the same as that of the first preferred embodiment except the following:

The IR heating member 5 and its associate components, and the electric razor 60 and its associated components provided.

While the invention has been described in terms of preferred embodiments, those skilled in the art will recognize that the invention can be practiced with modifications within the spirit and scope of the appended claims.

What is claimed is:

1. A multifunction, portable communication device comprising:
a parallelepiped housing including a solar cell disposed on a top surface and a Universal Serial Bus (USB) port disposed on an edge;
a printed circuit board (PCB) disposed in the housing and electrically connected to the USB port;
a keypad disposed on the top surface of the housing and electrically connected to the PCB;
a rechargeable battery disposed in the housing and electrically connected to both the solar cell and the PCB; and
an infrared (IR) heating member disposed in the housing and electrically connected to the PCB, the keypad, and the rechargeable battery respectively, the IR heating member including an electromagnetic radiation member.

2. A multifunction, portable communication device comprising:
a parallelepiped housing including a solar cell disposed on a top surface and a Universal Serial Bus (USB) port disposed on an edge;
a printed circuit board (PCB) disposed in the housing and electrically connected to the USB port;
a keypad disposed on the top surface of the housing and electrically connected to the PCB;
a rechargeable battery disposed in the housing and electrically connected to both the solar cell and the PCB;
a direct current (DC) motor disposed in the housing and electrically connected to the PCB; and
an electric razor projecting out of the housing and powered by the DC motor.

3. A multifunction, portable communication device comprising:
a parallelepiped housing including a solar cell disposed on a top surface and a Universal Serial Bus (USB) port disposed on an edge;
a printed circuit board (PCB) disposed in the housing and electrically connected to the USB port;
a keypad disposed on the top surface of the housing and electrically connected to the PCB;
a rechargeable battery disposed in the housing and electrically connected to both the solar cell and the PCB;
an infrared (IR) heating member disposed in the housing and electrically connected to the PCB, the keypad, and the rechargeable battery respectively, the IR heating member including an electromagnetic radiation member;
a direct current (DC) motor disposed in the housing and electrically connected to the PCB; and
an electric razor projecting out of the housing and powered by the DC motor.
